(19) United States
(12) Patent Application Publication
(10) Pub. No.: US 2022/0394725 A1
(43) Pub. Date: Dec. 8, 2022

(54) User-Equipment-Coordination-Set Scheduling

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/765,279

(22) PCT Filed: Aug. 11, 2020
(86) PCT No.: PCT/US2020/045777

§ 371 Date: Mar. 30, 2022

Related U.S. Application Data
(60) Provisional application No. 62/924,976, filed on Oct. 23, 2019.

(51) Int. Cl. H04W 72/12; H04W 72/14

(52) U.S. Cl. CPC H04W 72/121; H04W 72/14

(57) ABSTRACT

This document describes methods, devices, systems, and means for user-equipment-coordination-set (UESC) scheduling in which a coordinating user equipment receives an indication from a base station specifying multiple user equipments to include in the user-equipment-coordination set. The coordinating user equipment allocates resources to each of the multiple user equipments for communication using the local wireless network and transmits a UECS resource grant to each of the multiple user equipments for communication using the local wireless network. The coordinating user equipment communicates with the multiple user equipments, using the resources granted in the UECS resource grants for the local wireless network, to coordinate a joint communication between the user-equipment-coordination set and the base station. The coordinating user equipment participates in the joint communication, with the multiple user equipments, to communicate data with the base station for a target user equipment in the user-equipment-coordination set.

### BACKGROUND

A user-equipment-coordination set (UECS) is formed by multiple user equipments (UEs) assigned as a group to function together similarly to a distributed antenna for the benefit of a particular user equipment (e.g., target UE). The UECS includes a coordinating UE that coordinates joint transmission and reception of downlink and/or uplink data for the target UE or multiple UEs in the UE-coordination set. By combining antennas and transceivers of multiple UEs in the UE-coordination set, joint communication improves the link budget for communication, as compared to a single UE communicating with the base station.

### SUMMARY

This summary is provided to introduce simplified concepts of user-equipment-coordination-set scheduling. The simplified concepts are further described below in the Detailed Description. This summary is not intended to identify essential features of the claimed subject matter nor is it intended for use in determining the scope of the claimed subject matter.

In aspects, methods, devices, systems, and means for scheduling local wireless network communication by a user equipment configured as a coordinating user equipment for a user-equipment-coordination set in a wireless communications network are described. The coordinating user equipment receives an indication from a base station specifying multiple user equipments to include in the user-equipment-coordination set and allocates air-interface resources to each of the multiple user equipments for communication using the local wireless network. The coordinating user equipment transmits a UECS resource grant to each of the multiple user equipments for communication using the local wireless network and communicates with the multiple user equipments, using the resources granted in the UECS resource grants for the local wireless network, to coordinate a joint communication between the user-equipment-coordination set and the base station. The coordinating user equipment participates in the joint communication, with the multiple user equipments, to communicate data with the base station for a target user equipment in the user-equipment-coordination set.

### BRIEF DESCRIPTION OF THE DRAWINGS

The details of one or more aspects of user-equipment-coordination-set scheduling are described below. The use of the same reference numbers in different instances in the description and the figures indicate similar elements:

FIG. 1 illustrates an example operating environment in which aspects of user-equipment-coordination-set scheduling can be implemented.

FIG. 2 illustrates an example device diagram of a user equipment and a serving cell base station.

FIG. 3 illustrates an air interface resource that extends between a user equipment and a base station and with which various aspects of user-equipment-coordination-set scheduling can be implemented.

FIG. 4 illustrates an example environment in which various aspects of user-equipment-coordination-set scheduling can be implemented.

FIG. 5 illustrates example data and control transactions between devices of a user-equipment-coordination set and a base station in accordance with aspects of user-equipment-coordination-set scheduling.

FIG. 6 illustrates an example method of user-equipment-coordination-set scheduling as generally related to the coordinating user equipment in accordance with aspects of the techniques described herein.

### DETAILED DESCRIPTION

This document describes methods, devices, systems, and means for user-equipment-coordination-set (UE-coordination set, UECS) scheduling in which a coordinating user equipment receives an indication from a base station specifying multiple user equipments to include in the user-equipment-coordination set. The coordinating user equipment allocates air interface resources to each of the multiple user equipments for communication using the local wireless network and transmits a UECS resource grant to each of the multiple user equipments for communication using the local wireless network. The coordinating user equipment communicates with the multiple user equipments, using the resources granted in the UECS resource grants for the local wireless network, to coordinate a joint communication between the user-equipment-coordination set and the base station. The coordinating user equipment participates in the joint communication, with the multiple user equipments, to communicate data with the base station for a target user equipment in the user-equipment-coordination set.

A UE-coordination set is formed by multiple UEs assigned as a group to function together, similarly to a distributed antenna, for the benefit of a particular UE. The UE-coordination set includes a coordinating UE that coordinates joint transmission and reception of downlink and/or uplink data for the particular UE (e.g., target UE) or multiple UEs in the UE-coordination set. By combining antennas and transmitters of multiple UEs in the UE-coordination set, the effective transmit power of the particular UE is significantly increased, and the effective signal quality is greatly improved.

Multiple UEs can each receive downlink data transmissions from the base station. Unlike conventional relay techniques, these UEs do not decode the downlink transmissions into data packets and then forward the data packets to a destination. Rather, the UEs demodulate and sample the downlink transmissions to produce I/Q samples. The UEs determine where to forward the I/Q samples of the downlink transmissions, such as to a coordinating UE or a target UE for decoding. In aspects, the target UE may be included in a subset of target UEs within the UE-coordination set. The coordinating UE (or the target UE) receives the I/Q samples from the other UEs in the UE-coordination set and stores the I/Q samples in a buffer memory for decoding. Then, the coordinating UE (or the target UE) synchronizes and decodes the stored I/Q samples into data packets for the target UE(s). Accordingly, the processing of the I/Q samples occurs at the coordinating UE or the target UE. In this way, the UE-coordination set acts as a distributed antenna for the target UE. The target UE includes its own antenna(s) and participates in the reception, demodulation, and sampling of downlink transmissions from the base stations and forwards the sampled I/Q data to the coordinating UE. However, if the target UE is the coordinating UE, then the target UE does not forward the I/Q samples to itself.

In one use case, multiple UEs can form a UE-coordination set to transmit a message to a base station at a higher effective transmit power than would be possible for an individual UE. Additionally, those UEs can form a UE-coordination set to receive a message from the base station for one of the UEs with greater effective receive sensitivity than would be possible for an individual UE. One of the multiple UEs acts as a coordinating UE for the UE-coordination set to aggregate data signals intended for a target UE and received by the UE-coordination set. Each of the UEs demodulates and samples the radio frequency signals and forwards the baseband samples to the coordinating UE using a local wireless network. Then, the coordinating UE aggregates and processes the samples to generate decoded data and provides the decoded data to the target UE. Alternatively, the coordinating UE can forward the stored samples to the target UE to allow the target UE to decode the data.

In aspects, a coordinating UE schedules communication between UEs in the UECS to enable joint transmission and/or joint reception by the UECS. The coordinating UE schedules communication within the UECS using local wireless network. The local wireless network can use an unlicensed wireless technology, Radio Access Network (RAN) resources allocated by the base station to the UECS for the local wireless network, or resources in Citizens Broadband Radio Service (CBRS) radio spectrum granted by a CBRS Spectrum Access System (SAS).

In other aspects, the coordinating UE schedules communication within the UECS based on a number of factors. For example, the coordinating UE receives a Channel Quality Indicator (CQI) and/or a power headroom report for local wireless network communication from each UE in the UECS. The coordinating UE uses the received CQI and/or power headroom report to configure communication between the UEs within the local wireless network of the UECS.

In further aspects, the coordinating UE allocates air interface resources for communication within the UECS based on the state of the UEs in the UECS. For example, the coordinating UE receives coordination buffer status reports from the UEs in the UECS. The coordinating UE allocates communication resources within the UECS based on the coordination buffer status reports received from the UEs in the UECS.

### Example Environment

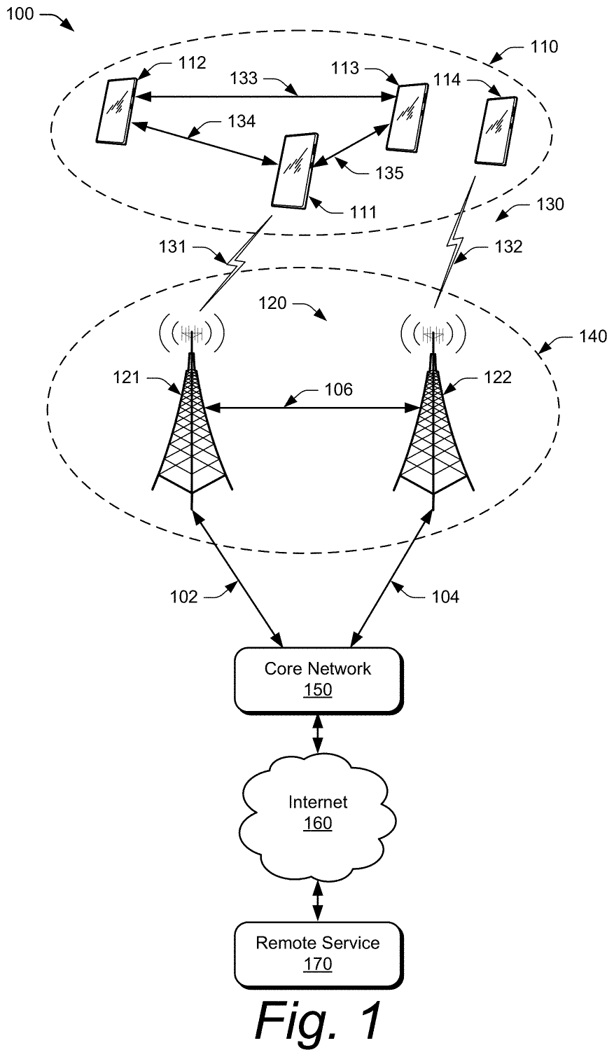

FIG. 1 illustrates an example environment 100, which includes multiple user equipments 110 (UE 110), illustrated as UE 111, UE 112, UE 113, and UE 114. Each UE 110 can communicate with one or more base stations 120 (illustrated as base stations 121 and 122) through one or more wireless communication links 130 (wireless link 130), illustrated as wireless links 131 and 132. Each UE 110 in a UE-coordination set (illustrated as UE 111, UE 112, and UE 113) can communicate with a coordinating UE of the UE-coordination set and/or a target UE in the UE-coordination set through one or more local wireless network connections (e.g., WLAN, Bluetooth, NFC, a personal area network (PAN), WiFi-Direct, IEEE 802.15.4, ZigBee, Thread, millimeter wavelength communication (mmWave), or the like) such as local wireless network connections 133, 134, and 135. Although illustrated as a smartphone, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, an Internet-of-things (IoT) device (e.g., sensor node, controller/actuator node, combination thereof), and the like. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, or the like, or any combination thereof.

The base stations 120 communicate with the user equipment 110 using the wireless links 131 and 132, which may be implemented as any suitable type of wireless link. The wireless links 131 and 132 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an Si interface for control-plane signaling and user-plane data communications when connecting to an Evolved Packet Core (EPC) network. The base stations 121 and 122 can communicate using an Xn Application Protocol (XnAP) through an Xn interface or using an X2 Application Protocol (X2AP) through an X2 interface, at 106, to exchange user-plane and control-plane data. The user equipment 110 may connect, via the core network 150, to public networks, such as the Internet 160 to interact with a remote service 170.

### Example Devices

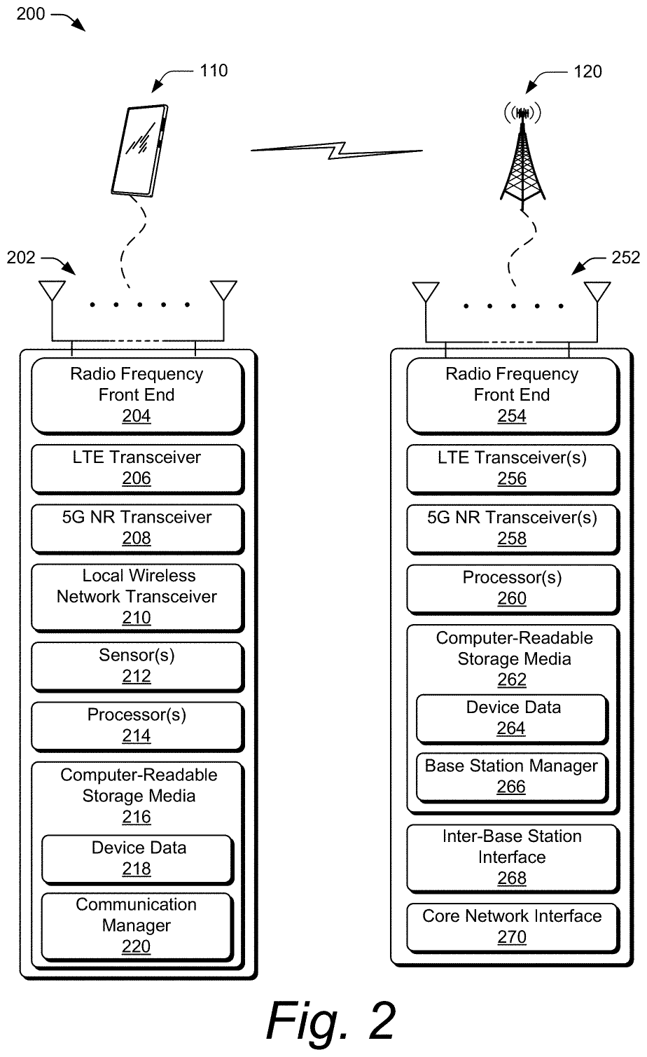

FIG. 2 illustrates an example device diagram 200 of a user equipment and a base station. In aspects, the device diagram 200 describes devices that can implement various aspects of UE-coordination-set scheduling. Included in FIG. 2 are the multiple UE 110 and the base stations 120. The multiple UE 110 and the base stations 120 may include additional functions and interfaces that are omitted from FIG. 2 for the sake of clarity. The UE 110 includes antennas 202, a radio frequency front end 204 (RF front end 204), and radio-frequency transceivers (e.g., an LTE transceiver 206 and a 5G NR transceiver 208) for communicating with base stations 120 in the 5G RAN 141 and/or the E-UTRAN 142. The UE 110 includes one or more additional transceivers (e.g., local wireless network transceiver 210) for communicating over one or more wireless local wireless networks (e.g., WLAN, Bluetooth, NFC, a personal area network (PAN), WiFi-Direct, IEEE 802.15.4, ZigBee, Thread, mmWave, or the like) with at least the coordinating UE, and/or the target UE, of the UE-coordination set. The RF front end 204 of the UE 110 can couple or connect the LTE transceiver 206, the 5G NR transceiver 208, and the local wireless network transceiver 210 to the antennas 202 to facilitate various types of wireless communication.

The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards. In addition, the RF front end 204 can be tuned to, and/or be tunable to, one or more frequency bands defined and implemented by the local wireless network transceiver 210 to support transmission and reception of communications with other UEs in the UE-coordination set over a local wireless network.

The UE 110 includes sensor(s) 212 can be implemented to detect various properties such as temperature, supplied power, power usage, battery state, or the like. As such, the sensors 212 may include any one or a combination of temperature sensors, thermistors, battery sensors, and power usage sensors.

The UE 110 also includes processor(s) 214 and computer-readable storage media 216 (CRM 216). The processor 214 may be a single core processor or a multiple core processor composed of a variety of materials, such as silicon, polysilicon, high-K dielectric, copper, and so on. The computer-readable storage media described herein excludes propagating signals. CRM 216 may include any suitable memory or storage device such as random-access memory (RAM), static RAM (SRAM), dynamic RAM (DRAM), non-volatile RAM (NVRAM), read-only memory (ROM), or Flash memory useable to store device data 218 of the UE 110. The device data 218 includes user data, multimedia data, beamforming codebooks, applications, and/or an operating system of the UE 110, which are executable by processor(s) 214 to enable user-plane communication, control-plane signaling, and user interaction with the UE 110.

CRM 216 also includes a communication manager 220 (e.g., a communication manager application 220). Alternately or additionally, the communication manager 220 may be implemented in whole or part as hardware logic or circuitry integrated with or separate from other components of the UE 110. In at least some aspects, the communication manager 220 configures the RF front end 204, the LTE transceiver 206, the 5G NR transceiver 208, and/or the local wireless network transceiver 210 to implement the techniques described herein for UE-coordination-set selective participation.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with any UE 110 in a UE-coordination set.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, beamforming codebooks, applications, and/or an operating system of the base stations 120, which are executable by processor(s) 260 to enable communication with the UE 110.

CRM 262 also includes a base station manager 266 (e.g., base station manager application 266). Alternately or additionally, the base station manager 266 may be implemented in whole or part as hardware logic or circuitry integrated with or separate from other components of the base stations 120. In at least some aspects, the base station manager 266 configures the LTE transceivers 256 and the 5G NR transceivers 258 for communication with the UE 110, as well as communication with a core network. The base stations 120 include an inter-base station interface 268, such as an Xn and/or X2 interface, which the base station manager 266 configures to exchange user-plane and control-plane data between another base station 120, to manage the communication of the base stations 120 with the UE 110. The base stations 120 include a core network interface 270 that the base station manager 266 configures to exchange user-plane and control-plane data with core network functions and entities.

Air Interface Resources

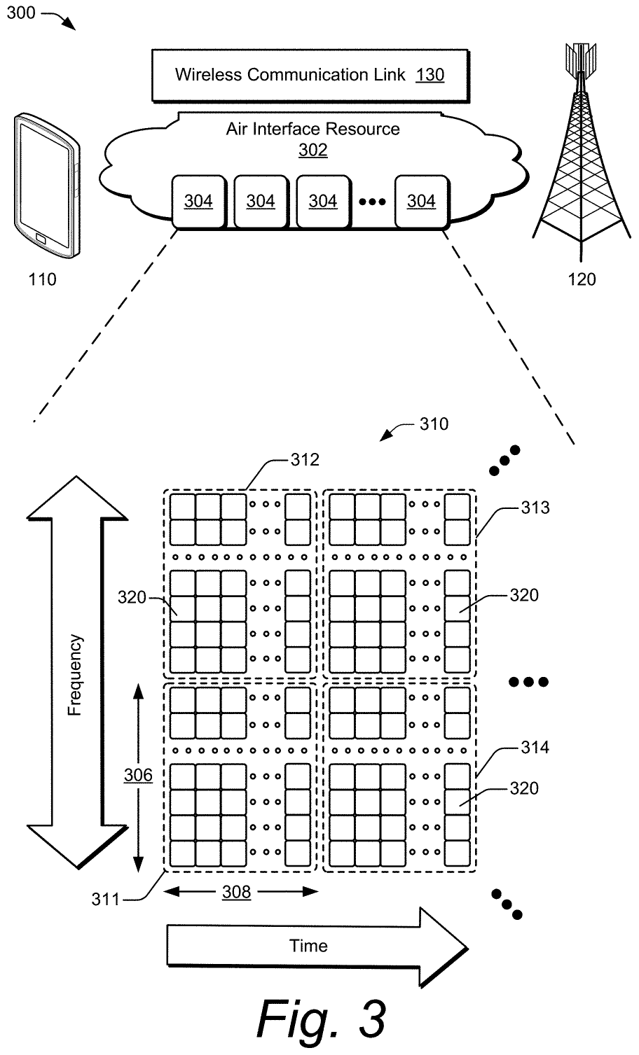

FIG. 3 illustrates an air interface resource that extends between a user equipment and a base station and with which various aspects of UE-coordination-set scheduling can be implemented. The air interface resource 302 can be divided into resource units 304, each of which occupies some intersection of frequency spectrum and elapsed time. A portion of the air interface resource 302 is illustrated graphically in a grid or matrix having multiple resource blocks 310, including example resource blocks 311, 312, 313, 314. An example of a resource unit 304 therefore includes at least one resource block 310. As shown, time is depicted along the horizontal dimension as the abscissa axis, and frequency is depicted along the vertical dimension as the ordinate axis. The air interface resource 302, as defined by a given communication protocol or standard, may span any suitable specified frequency range, and/or may be divided into intervals of any specified duration. Increments of time can correspond to, for example, milliseconds (mSec). Increments of frequency can correspond to, for example, megahertz (MHz).

In example operations generally, the base stations 120 allocate portions (e.g., the resource units 304) of the air interface resource 302 for uplink and downlink communications. Each resource block 310 of network access resources may be allocated to support respective wireless communication links 130 of multiple user equipments 110. In the lower left corner of the grid, the resource block 311 may span, as defined by a given communication protocol, a specified frequency range 306 and comprise multiple subcarriers or frequency sub-bands. The resource block 311 may include any suitable number of subcarriers (e.g., 12) that each correspond to a respective portion (e.g., 15 kHz) of the specified frequency range 306 (e.g., 180 kHz). The resource block 311 may also span, as defined by the given communication protocol, a specified time interval 308 or time slot (e.g., lasting approximately one-half millisecond or 7 orthogonal frequency-division multiplexing (OFDM) symbols). The time interval 308 includes subintervals that may each correspond to a symbol, such as an OFDM symbol. As shown in FIG. 3, each resource block 310 may include multiple resource elements 320 (REs) that correspond to, or are defined by, a subcarrier of the frequency range 306 and a subinterval (or symbol) of the time interval 308. Alternatively, a given resource element 320 may span more than one frequency subcarrier or symbol. Thus, a resource unit 304 may include at least one resource block 310, at least one resource element 320, and so forth.

In example implementations, multiple user equipments 110 (one of which is shown) are communicating with the base stations 120 (one of which is shown) through access provided by portions of the air interface resource 302. The base station manager 266 (shown in FIG. 2) may determine a respective data-rate, type of information, or amount of information (e.g., data or control information) to be communicated (e.g., transmitted) by the user equipment 110. For example, the base station manager 266 can determine that each user equipment 110 is to transmit at a different respective data rate or transmit a different respective amount of information. The base station manager 266 then allocates one or more resource blocks 310 to each user equipment 110 based on the determined data rate or amount of information.

Additionally, or in the alternative to block-level resource grants, the base station manager 266 may allocate resource units at an element-level. Thus, the base station manager 266 may allocate one or more resource elements 320 or individual subcarriers to different user equipment 110. By so doing, one resource block 310 can be allocated to facilitate network access for multiple user equipments 110. Accordingly, the base station manager 266 may allocate, at various granularities, one or up to all subcarriers or resource elements 320 of a resource block 310 to one user equipment 110 or divided across multiple user equipments 110, thereby enabling higher network utilization or increased spectrum efficiency.

The base station manager 266 can therefore allocate air interface resource 302 by resource unit 304, resource block 310, frequency carrier, time interval, resource element 320, frequency subcarrier, time subinterval, symbol, spreading code, some combination thereof, and so forth. Based on respective allocations of resource units 304, the base station manager 266 can transmit respective messages to the multiple user equipments 110 indicating the respective allocation of resource units 304 to each user equipment 110. Each message may enable a respective user equipment 110 to queue the information or configure the LTE transceiver 206 and/or 5G NR transceiver 208 to communicate via the allocated resource units 304 of the air interface resource 302.

UE-Coordination Set

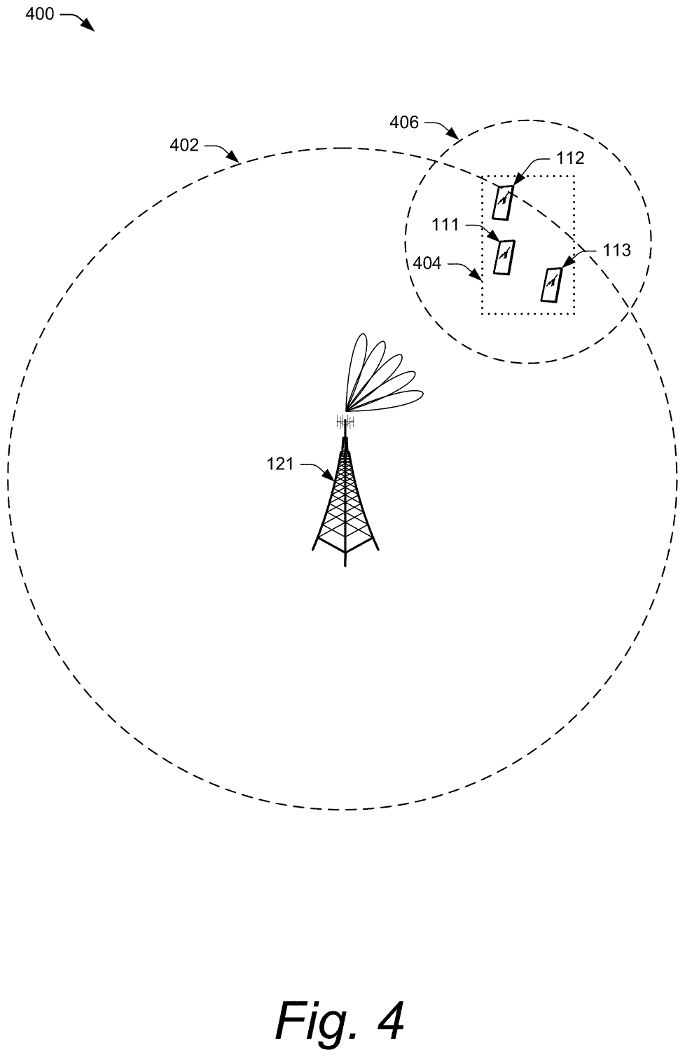

FIG. 4 illustrates an example implementation 400 of user-equipment-coordination-set scheduling. The illustrated example includes a base station 121, UE 111, UE 112, and UE 113. Although, for the sake of illustration clarity, the UECS in FIG. 4 is illustrated as including three UEs, any suitable number of UEs may be included in a UECS. In an example, each of the UEs illustrated in FIG. 4 has limited transmit power which may result in difficulty transmitting uplink data to the base station 121. This may be due, at least partially, to the UEs being proximate to a cell edge 402 of the cell provided by the base station 121 or the UEs being in a transmission-challenged location (e.g., a basement, urban canyon, etc.) resulting in a poor link budget between the base station 121 and the UEs. Each of the UEs illustrated in FIG. 4 may also, or alternatively, have limited receiver sensitivity, which may be affected by a poor link budget with the base station 121, as well as multipath reception, interference from in-band or out-of-band sources, attenuation from weather conditions or objects such as buildings, trees, etc.

Using the techniques described herein, the base station 121 can specify a set of UEs (e.g., the UE 111, UE 112, and UE 113) to form a UE-coordination set (e.g., the UE-coordination set 404, UECS 404) for joint transmission and joint reception of data for a target UE (e.g., the UE 112). The base station 121 may determine, based on information corresponding to the UEs (e.g., UE location, signal level, battery level, and so on), whether coordination is beneficial for a particular UE or not. Based on a user input or predefined setting, each of the UEs may opt in or out of participation in the UE-coordination set. An effective transmit power of the target UE 112 can increase significantly (e.g., linearly) with the number of UEs in the UE-coordination set, which can greatly improve a link budget of the target UE 112. The base station 121 may determine a UE-coordination set based on various factors, such as a location of each UE relative to the base station 121, distance between the UEs (such as between each other, between each UE and the target UE, or between each UE and a coordinating UE of the UE-coordination set) or a combination thereof. In some aspects, UEs within a certain distance of each other can more easily coordinate with one another to reduce signal interference when in close proximity by using a local wireless network.

In addition, UE coordination can be based on spatial beams or timing advance, or both, associated with each UE. For example, for beamforming or Massive-MIMO, it may be desirable that all the UEs within the UE-coordination set are able to receive the same signal from the base station. Therefore, all the UEs within the UE-coordination set may be geographically near one another, e.g., within a threshold distance of a particular UE in the UE-coordination set. In this way, the UEs in the UE-coordination set may each be in the same beam or beams that are close to each other. Timing advance may indicate a distance between a UE and the base station. A similar timing advance for each UE in a group indicates that those UEs are approximately the same distance from the base station. UEs within a predefined distance of one another that are all a similar distance from the base station may be capable of working together in a UE-coordination set in a distributed fashion to improve a signal strength and quality to the benefit of a single UE in the UE-coordination set.

The base station can send layer-2 messages (e.g., Medium Access Control layer) and/or layer-3 (e.g., Service Data Adaptation Protocol layer) messages to UEs to direct or request those UEs to join the UE-coordination set. The base station can provide additional data to the UEs within the UE-coordination set to enable the UEs to communicate with at least the coordinating UE or the target UE. The additional data may include an identity of the coordinating UE and/or an identity of the target UE, security information, and/or local wireless network information.

The base station can receive a response message from a UE in the UE-coordination set acknowledging the request message. In some cases, the base station can receive a response message from at least two of the UEs acknowledging that a UE has joined the UE-coordination set. The response message may indicate that by a user of the UE has approved the request message.

In addition, the base station can identify and command (or request) a specific UE within the UE-coordination set to act as a coordinating UE (e.g., master UE) for the UE-coordination set. For example, the base station 121 can transmit a configuration message (e.g., request message) to the specific UE to request that the specific UE act as the coordinating UE for the UE-coordination set. The specific UE may accept or decline the request based on user input from a user of the UE or a setting that is set to automatically accept or decline such requests. In some aspects, the UE may transmit a UE-capability message or other layer-3 message as a response to the request message from the base station 121. The coordinating UE can coordinate the messages and samples sent between UEs within the UE-coordination set for joint transmission and joint reception. In aspects, the coordinating UE can determine where the joint processing is to occur, e.g., at the coordinating UE or the target UE. In an example, the coordinating UE can coordinate how a particular UE in the UE-coordination set is to send I/Q samples, which the particular UE demodulates from signals received from the base station, to the target UE.

The base station can select the coordinating UE from the group of UEs in the UE-coordination set based on a variety of factors, some of which may be signaled to the base station by the UE using a UE-capability message. For example, one factor includes processing power of the coordinating UE, which provides the coordinating UE the capability to handle certain aspects of the UE-coordination set including central coordination or scheduling. Another factor may include a battery-level state of the coordinating UE. For instance, if a particular UE in the UE-coordination set has a low battery, then that UE may not be a good candidate to act as the coordinating UE. Accordingly, UEs within the UE-coordination set that have a battery-level state above a threshold value may be considered as candidates for selection as the coordinating UE. In one example, the base station may first select one UE as a coordinating UE, and receive, subsequent to formation of the UE-coordination set, messages from the other UEs in the UE-coordination set indicating respective battery-level states. Then, the base station can change the coordination UE if another UE in the UE-coordination set would be a better candidate based on the battery-level states of the UEs in the UE-coordination set.

Yet another factor may include a location of the coordinating UE. The base station may identify the location of the UEs in the UE-coordination set based on various factors, such as angle of arrival of signals from the UE, timing advance, observed time difference of arrival (OTDOA), and so on. An ideal location for the coordinating UE may be geographically central in the UE-coordination set as this may maximize the coordinating UE's capability to coordinate and communicate with the other UEs in the UE-coordination set. However, the coordinating UE is not required to be in a central location of the UEs in the UE-coordination set. Rather, the coordinating UE can be located at any location within the UE-coordination set that allows the coordinating UE to communicate and coordinate with the other UEs in the UE-coordination set. The base station constantly monitors the UE-coordination set and can update the coordinating UE at any time based on updated factors, such as updated UE locations, UE battery-level state, and so on. Or, as mentioned previously, the coordinating UE may transfer its joint processing responsibilities to another UE based on factors such as processing power, battery level, and/or geographic location.

In some aspects, the base station can receive indications from one or more UEs in the UE-coordination set that advertise their capability to act as the coordinating UE. Additionally or alternatively, the base station can receive indications from one or more UEs in the UE-coordination set that indicate a willingness of a user of a respective UE to allow their UE to participate in the UE-coordination set and/or act as the coordinating UE. Accordingly, a UE in the UE-coordination set can indicate, using a layer-3 message, to the base station whether it is capable of acting and/or is permitted to act as the coordinating UE.

In the illustrated example 400 in FIG. 4, the base station 121 may select UE 111 to act as the coordinating UE since the UE 111 is located between UE 112 and UE 113 or because the UE 111 is capable of communicating with each of the other UEs 112 and 113 in the UE-coordination set. The base station 121 may select the coordinating UE for various reasons, examples of which are described above. Being at the cell edge, all three of the UEs 111, 112, 113 have weak cellular signal reception. The base station 121 selects UE 111 to coordinate messages and samples sent between the base station 121 and the UEs 111, 112, 113 for the target UE 112. Communication among the UEs can occur using a local wireless network 406, such as a PAN, NFC, Bluetooth, WiFi-Direct, local mmWave link, etc. In this example, all three of the UEs 111, 112, 113 receive RF signals from the base station 121. The UE 111, UE 112, and UE 113 demodulate the RF signals to produce baseband I/Q analog signals, and sample the baseband I/Q analog signals to produce I/Q samples. The UE 112 and the UE 113 forward the I/Q samples along with system timing information (e.g., system frame number (SFN)) using the local wireless network 406 to the coordinating UE 111 using the local wireless network transceiver 210. The coordinating UE 111 then uses the timing information to synchronize and combine the I/Q samples and processes the combined signal to decode data packets for the target UE 112. The coordinating UE 111 then transmits the data packets to the target UE 112 using the local wireless network 406.

When the target UE 112 has uplink data to send to the base station 121, the target UE transmits the uplink data to the coordinating UE 111 that uses the local wireless network 406 to distribute the uplink data, as I/Q samples, to each UE in the UE-coordination set 404. Each UE in the UE-coordination set 404 synchronizes with the base station 121 for timing information and its data transmission resource assignment. Then, all three UEs in the UE-coordination set 404 jointly transmit the uplink data to the base station 121. The base station 121 receives the jointly transmitted uplink data from the UEs 111, 112, 113 and processes the combined signal to decode the uplink data from the target UE 112.

User-Equipment-Coordination-Set Scheduling

In aspects, to enable joint transmission and/or joint reception by a UECS, the coordinating UE schedules communication within the UECS, such as communication within the local wireless network between the coordinating UE and the other UEs in the UECS. The local wireless network can use an unlicensed wireless technology (as discussed above), licensed-band RAN resources allocated by the base station to the UECS for the local wireless network, or resources in Citizens Broadband Radio Service (CBRS) radio spectrum granted by a CBRS Spectrum Access System (SAS) to the UECS.

For UECS scheduling using licensed band resources, the base station 121 grants air interface resources 302 to the coordinating UE 111 for the local wireless network. The coordinating UE 111 in turn allocates portions of those air interface resources 302 as needed for communication with the other UEs (e.g., UE 112 and/or UE 113) in the UECS 404. For UECS scheduling using a CBRS spectrum grant, the base station 121 allocates a portion of the resources in the CBRS spectrum grant to the coordinating UE 111 for the local wireless network. The remaining resources in the CBRS spectrum grant are used for joint reception and/or joint transmission between the UECS and the base station 121. The coordinating UE 111 in turn allocates the portion of the resources in the CBRS spectrum grant allocated for the local wireless network as needed for communication with the other UEs (e.g., UE 112 and/or UE 113) in the UECS 404.

For UECS scheduling using unlicensed radio spectrum for the local wireless network, the base station 121 groups UEs with similar local wireless capabilities into a UECS. When the base station 121 assigns a UE to a UECS, the base station provides a local wireless network configuration that enables that UE to communicate with the coordinating UE. The coordinating UE schedules air interface resources of the unlicensed radio spectrum as needed for communication with the other UEs (e.g., UE 112 and/or UE 113) in the UECS 404. The coordinating UE 111 may additionally alter operating parameters of the UEs for the unlicensed local wireless network based on the operating environment of the UECS by sending unicast, multicast, or broadcast communications to one or more UEs in the UECS.

The coordinating UE determines resource grants and operating parameters for communication on the local wireless network based on measurement and/or status information provided by each of the UEs in the UECS. For example, each of the UEs in the UECS determines a UECS-specific Channel Quality Indicator (CQI) (e.g., a signal-to-interference-plus-noise ratio (SINR) observed at the UE) for communication received from the coordinating UE over the wireless local network. Each UE transmits the UECS-specific CQI to the coordinating UE. The coordinating UE evaluates each of the received UECS-specific CQIs to determine an appropriate Modulation and Coding Scheme (MCS) for each UE in the UECS. The coordinating UE transmits the MCS configuration and an associated resource grant to each UE to use for coordinating communication within the UECS. For example, in the cases of licensed or CBRS spectrum, the resource grant is a portion of the resource grant provided to the UECS by the base station. In the case of unlicensed spectrum, the coordinating UE may transmit operating parameters for the wireless local network, such as a radio channel or frequency for the wireless local network, a channel bandwidth, a preamble detection threshold, or the like.

In one aspect, the coordinating UE can send a UECS-specific power control command to each UE in the UECS that specifies the transmit power for that UE to use for coordination of joint transmission and joint reception with the base station. Each UE in the UECS transmits a UECS-specific power headroom report to the coordinating UE. The coordinating UE uses the UECS-specific power headroom report to determine a transmit power for each UE. The coordinating UE transmits the UECS-specific power control command to each UE to indicate the transmit power that each respective UE is to use for coordinating communication within the UECS.

In another aspect, the coordinating UE may determine from signals received from a UE over the local wireless network that a timing advance adjustment is needed for the UE. The coordinating UE can send a UECS-specific timing advance command to a UE in the UECS that specifies the timing advance for that UE to use for coordination of joint transmission and joint reception with the base station.

In a further aspect, the coordinating UE transmits synchronization signals to enable other UEs, especially a UE that is newly-added to the UECS, to find the coordinating UE on the local wireless network. For example, when a base station adds a UE to a UECS, the base station specifies the timing and frequency for a synchronization signal that the coordinating UE transmits to enable the newly-added UE in the UECS to find the coordinating UE and synchronize UECS operations using the local wireless network. A synchronization signal can be specific to an individual UE, a subset of UEs, or all the UEs in the UECS.

In other aspects, the coordination UE sends a scheduling command to each UE in the UECS to coordinate joint communication with the base station. The scheduling command includes an indication of time and frequency resources for the UEs in the UECS to use to communicate with the coordinating UE within the UECS for the joint communication. Each UE in the UECS has a specific identity to indicate to each specific UE that a scheduling command is specific to that UE. Optionally or additionally, the scheduling command may include an indication of the time and frequency resources for the UEs to use for the joint communication with the base station 121.

In another aspect, each UE in the UECS can send a coordination buffer status report to the coordinating UE. The coordinating UE uses the received coordination buffer status report(s) to schedule air interface resources within the UECS for joint communication of the data indicated in the buffer status reports. For example, as a result of receiving a coordination buffer status report from a UE, the coordinating UE allocates resources based on the coordination buffer status report and transmits a scheduling command that includes an indication of the allocated resources to the UE.

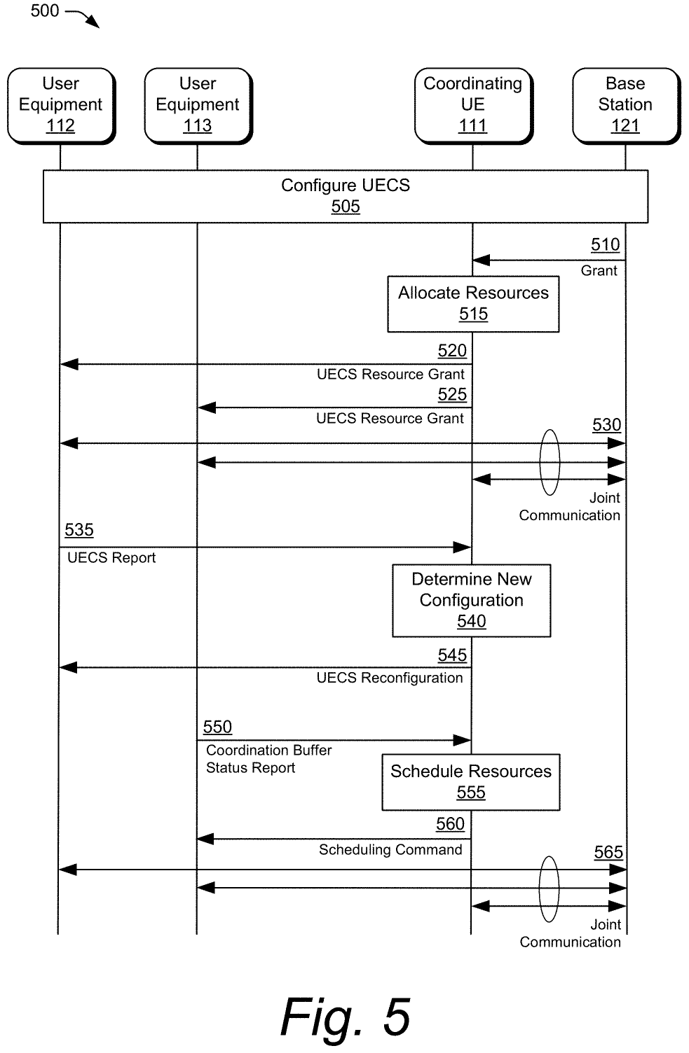

FIG. 5 illustrates data and control transactions between devices of a user-equipment-coordination set and a base station for joint communication participation in a user-equipment-coordination set in accordance with aspects of user-equipment-coordination-set scheduling. Although not illustrated for the sake of illustration clarity, various acknowledgements for messages illustrated in FIG. 5 may be implemented to ensure reliable operations of UECS selective participation.

At 505 and as described above with respect to FIG. 4, the base station 121 configures a UECS (e.g., the UECS 404) including the UE 111, the UE 112, and the UE 113. The base station 121 configures the UE 111 as the coordinating UE for the UECS. Although, for the sake of illustration clarity, the UECS in FIG. 5 is illustrated as including three UEs, any suitable number of UEs may be included in the UECS. The configuration 505 of the UECS 404 can include the base station 121 transmitting timing and frequency information for synchronization signals that the coordinating UE transmits to enable other UEs in the UECS to find the coordinating UE and synchronize UECS operations using the local wireless network. For example, the configuration 505 of the UECS 404 can include the coordinating UE 111 transmitting synchronization signals to enable the UE 112 and the UE 113 to synchronize with the coordinating UE 111 over the local wireless network.

At 510, the base station 121 transmits a resource grant for the UECS 404 to the coordinating UE 111. The resource grant includes an indication of the air interface resources for joint communication between the UECS 404 and the base station 121. The resource grant may include licensed-band RAN resources or CBRS spectrum grant resources for the local wireless network used by the UECS 404. The base station 121 may include an indication in the resource grant of the type of resources that are included (e.g., resources for joint communication, resources for the local wireless network, or both). If resources for joint communication and resources for the local wireless network are included in the resource grant, the base station 121 may include an indication of which resources in the grant are assigned to joint communication and which resources in the grant are assigned to the local wireless network.

Alternatively at 510, if the local wireless network uses unlicensed spectrum, the resource grant includes air interface resources for joint communication between the UECS 404 and the base station 121. The resource grant may also include a local wireless network configuration that enables that UEs to communicate within the UECS. Alternatively, the local wireless network configuration can be communicated separately from the resource grant.

At 515, the coordinating UE 111 allocates air interface resources for the local wireless network to each of the UEs in the UECS 404. At 520 and 525, the coordinating UE 111 transmits UECS resource grants for the local wireless network and for joint communication to the UE 112 and UE 113, respectively. At 520 and as described above with respect to FIG. 4, the UEs 111, 112, and 113 used the granted resources for joint communication with the base station 121.

Periodically, triggered by changing channel conditions, or in response to a request from the coordinating UE 111, a UE in the UECS reports status or measurement information to the coordinating UE. At 535, the UE 112 transmits a UECS report to the coordinating UE 111. For example, the report can include a UECS-specific Channel Quality Indicator (CQI) for the local wireless network, a UECS-specific power headroom report for the local wireless network, or the like.

At 540, the coordinating UE 111 evaluates the information included in the UECS report and, if appropriate determines a reconfiguration of the settings for the UE 112. For example, if a UECS-specific CQI indicates that channel conditions over the local wireless network have deteriorated for the UE 112, the coordinating UE may determine a new MCS for communication between the coordinating UE 110 and the UE 112. In another example, based on a UECS-specific power headroom report for the UE 112, the coordinating UE may determine a new transmit power for communication between the coordinating UE 110 and the UE 112. At 545, the coordinating UE 111 transmits a UECS reconfiguration message to the UE 112 that includes the new configuration, determined by the coordinating UE 111, directing the UE 112 to reconfigure its communication settings for communication over the local wireless network.

At 550, the UE 113 has uplink data buffered for transmission to the base station 121. The UE 113 transmits a coordination buffer status report to the coordinating UE 111. At 555, after receiving the coordination buffer status report, the coordinating UE 111 schedules air interface resources for the UE 113 to transmit the buffered data to the coordinating UE 111 for joint transmission to the base station 121. Additionally or optionally, the coordinating UE 111 may also schedule additional air interface resources for other UEs in the UECS to facilitate local wireless network communications as needed in support of joint communication. At 560, the coordinating user equipment transmits a scheduling command including a resource schedule to the UE 113. Additionally or optionally, the coordinating UE 111 may also transmit a resource schedule to the other UEs in the UECS (not illustrated in FIG. 5). At 565, the UECS 404 jointly communicates with the base station 121 to transmit the buffered uplink data for the UE 113 (as described above with respect to FIG. 4).

Joint communication by the UE-coordination set 404 enhances a target UE's ability to transmit data to the base station 121 and receive data from the base station 121 by generally acting as a distributed antenna of the target UE. For example, the base station 121 transmits downlink data using RF signals to multiple UEs in the UE-coordination set 404. At least some of the multiple UEs demodulate the received RF signals to an analog baseband signal and sample the baseband signal to produce a set of I/Q samples, which the UEs send to the coordinating UE 111 along with system timing information. The coordinating UE 111 accumulates and stores the I/Q samples from each UE in a memory buffer. Because each of the UEs in the UE-coordination set 404 synchronizes with the base station 121, all of the UEs in the UE-coordination set 404 have a common time, based on a common time base (e.g., system frame number (SFN)), effective to enable the coordinating UE to manage the timing and aligning of the I/Q samples for the accumulation and storage of the I/Q samples in the memory buffer. For joint reception and decoding, the coordinating UE 111 processes the stored I/Q samples to decode the downlink data for the target UE. In aspects, I/Q samples can be processed at multiple UEs (e.g., less than all the UEs in the UE-coordination set), at the target UE, or at the coordinating UE 111. At least a subset of the UEs in the UE-coordination set 404 can participate in the accumulation and/or the joint processing of the downlink I/Q samples. In at least one aspect, the coordinating UE 111 can select which UEs in the UE-coordination set 404 are to be included in the subset of UEs that participate in the accumulation and/or the joint processing of the downlink I/Q samples. In other aspects, the base station 121 can make this selection. For joint transmission, multiple UEs in the UE-coordination set 404 each use their respective antennas and transmitters to transmit uplink data from the target UE on air interface resources as directed by the base station coordinating the UE-coordination set. In this way, the target UE's uplink data can be processed together and transmitted using the transmitters and the transmission antennas of multiple (including all) UEs in the UE-coordination set 404. In an example, the target UE uses its local wireless network transceiver 210 to transmit uplink data to the coordinating UE 111. The coordinating UE 111 uses its local wireless network transceiver 210 to distribute the data to the other UEs in the UE-coordination set 404. Then, all the UEs in the UE-coordination set 404 process and transmit the uplink data to the base station 121. In this way, the joint transmission provides for a better effective link budget for transmission of the uplink data for the target UE.

### Example Method

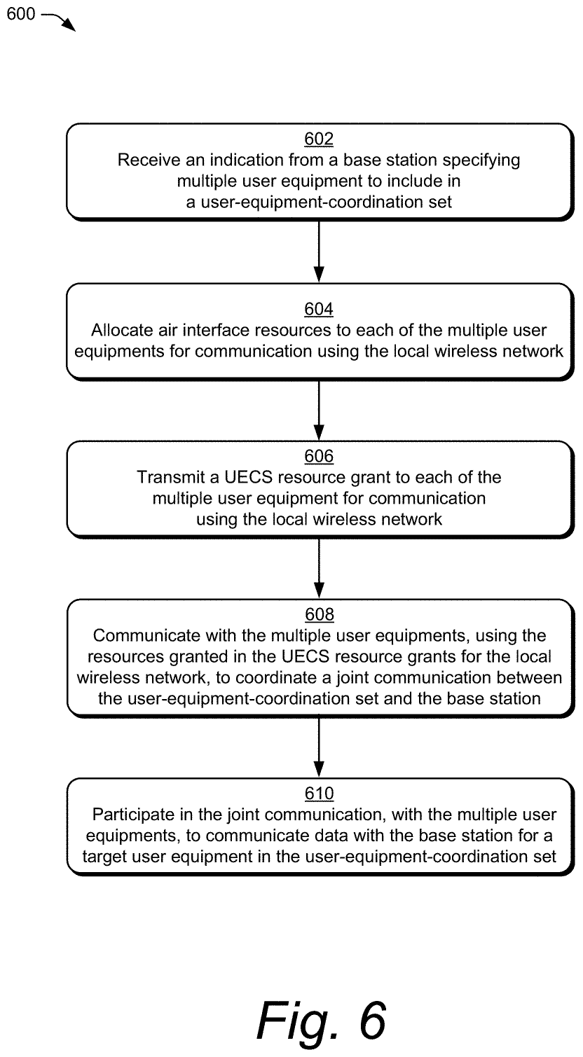

Example methods 600 is described with reference to FIG. 6 in accordance with one or more aspects of user-equipment-coordination-set scheduling. The order in which the method blocks are described are not intended to be construed as a limitation, and any number of the described method blocks can be skipped, repeated, or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 of user-equipment-coordination-set scheduling as generally related to a coordinating user equipment. At block 602, a coordinating user equipment receives an indication from a base station specifying multiple user equipments to include in a user-equipment-coordination set. For example, a coordinating user equipment (e.g., the coordinating UE 111) receives an indication from a base station (e.g., the base station 121) specifying multiple user equipments (e.g., UE 112, and UE 113) to include in a user-equipment-coordination set (e.g., the UECS 404). The coordinating user equipment also receives, from the base station, indications of time and frequency resources for synchronization signals to transmit over the local wireless network. The coordinating user equipment transmits those synchronization signals to enable other UEs in the UECS to find the coordinating UE.

At block 604, the coordinating user equipment allocates air interface resources to each of the multiple user equipments for communication using the local wireless network. For example, the coordinating user equipment allocates air interface resources from a resource grant of licensed spectrum resources received from the base station to each of the multiple user equipments for communication using the local wireless network. In another example, the coordinating user equipment allocates air interface resources from a CBRS radio spectrum grant received from the base station to each of the multiple user equipments for communication using the local wireless network. In a further example, the coordinating user equipment allocates air interface resources in unlicensed radio spectrum to each of the multiple user equipments for communication using the local wireless network.

At block 606, the coordinating user equipment transmits a UECS resource grant to each of the multiple user equipments for communication using the local wireless network. For example, the coordinating user equipment transmits a UECS resource grant (e.g., UECS resource grants 520, 525) to each of the multiple user equipments for communication using the local wireless network, the UECS resource grant indicating the allocated air interface resources.

At bock 608, the coordinating user equipment communicates with the multiple user equipments, using the resources granted in the UECS resource grants for the local wireless network, to coordinate a joint communication between the user-equipment-coordination set and the base station. For example, the coordinating user equipment communicates with the multiple user equipments, using the resources granted in the UECS resource grants for the local wireless network, to coordinate a joint communication between the user-equipment-coordination set and the base station as described above with respect to FIG. 4.

At block 610, the coordinating user equipment participates in joint communication, with the multiple user equipment, to communicate data with the base station for a target user equipment in the user-equipment-coordination set. For example, the coordinating user equipment may communicate samples to the multiple UEs for joint transmission, may receive samples from the UEs in the first subset for joint reception, or both.

In the following text, some examples are described.

Example 1: A method for scheduling local wireless network communication by a user equipment configured as a coordinating user equipment for a user-equipment-coordination set, UECS, in a wireless communications network, the method comprising the coordinating user equipment:

receiving an indication from a base station specifying multiple user equipments to include in the user-equipment-coordination set;

allocating air interface resources to each of the multiple user equipments for communication using a local wireless network;

transmitting a UECS resource grant to each of the multiple user equipments for communication using the local wireless network, the UECS resource grant indicating the allocated air interface resources;

communicating with the multiple user equipments, using the air interface resources granted in the UECS resource grants for the local wireless network, to coordinate a joint communication between the user-equipment-coordination set and the base station; and participating in the joint communication, with the multiple user equipments, to communicate data with the base station for a target user equipment in the user-equipment-coordination set.

Example 2: The method of example 1, further comprising the coordinating user equipment:

receiving a UECS report from a first user equipment of the multiple user equipments;

based on the received UECS report, determining a revised configuration of the first user equipment including one or more parameters for communication using the local wireless network; and

transmitting the revised configuration to the first user equipment, the revised configuration directing the first user equipment to use the one or more parameters to reconfigure the first user equipment for communication using the local wireless network.

Example 3: The method of example 2, wherein the UECS report includes a UECS-specific Channel Quality Indicator, CQI, for the local wireless network, measured by the first user equipment, and wherein the one or more parameters includes an indication of a Modulation and Coding Scheme, MCS, to use for communication using the allocated air interface resources for the local wireless network between the coordinating user equipment and the first user equipment.
Example 4: The method of example 2, wherein the UECS report includes a UECS-specific power headroom report for the local wireless network, and wherein the one or more parameters includes a UECS-specific power control command to indicate a transmit power for UECS transmissions by the first user equipment using the allocated air interface resources.
Example 5: The method of example 2, wherein the one or more parameters includes a timing advance that specifies the timing advance for the first UE to use for coordination of joint communication with the base station.
Example 6: The method of any preceding example, further comprising the coordinating user equipment:

receiving a coordination buffer status report of pending uplink data from a second user equipment;

based on the coordination buffer status report, scheduling air interface resources of the local wireless network to coordinate joint transmission of pending uplink data of the second user equipment; and

transmitting a scheduling command including a resource schedule to the second user equipment, the resource schedule including an indication of the scheduled air interface resources.

Example 7: The method of example 6, further comprising the coordinating user equipment:

transmitting scheduling commands including respective resource schedules to other user equipments in the UECS, wherein the respective resource schedules are specific to an individual user equipment in the UECS, a subset of user equipments in the UECS, or all the user equipments in the UECS.

Example 8: The method of any of the preceding examples, further comprising the coordinating user equipment:

receiving timing and frequency information for UECS synchronization signals from the base station; and

transmitting the UECS synchronization signals over the local wireless network, the transmitting being effective to enable the multiple user equipments receiving the UECS synchronization signals to synchronize communication with the coordinating user equipment over the local wireless network.

Example 9: The method of example 8, wherein a UECS synchronization signal is specific to an individual user equipment in the UECS, a subset of user equipments in the UECS, or all the user equipments in the UECS.
Example 10: The method of any preceding example, further comprising the coordinating user equipment:

receiving a resource grant of licensed spectrum resources from the base station, the resource grant including an indication of the licensed spectrum resources allocated by the base station for the local wireless network; and

wherein the allocating the air interface resources to each of the multiple user equipments comprises allocating at least a portion of the indicated licensed spectrum resources to each of the multiple user equipments for communication using the local wireless network.

Example 11: The method of example 10, wherein the resource grant of licensed spectrum resources from the base station includes resources granted for the local wireless network and resources granted for communication between the base station and the UECS.
Example 12: The method of any one of examples 1 to 9, further comprising the coordinating user equipment:

receiving a Citizens Broadband Radio Service, CBRS, radio spectrum grant from the base station, the CBRS radio spectrum grant including an indication of CBRS radio spectrum resources allocated by the base station for the local wireless network; and

the allocating the air interface resources to each of the multiple user equipments comprising allocating the indicated CBRS radio spectrum resources to each of the multiple user equipments for communication using the local wireless network.

Example 13: The method of example 12, wherein the CBRS radio spectrum grant from the base station includes resources granted for the local wireless network and resources granted for communication between the base station and the UECS.
Example 14: The method of any one of examples 1 to 9, wherein the local wireless network communicates using unlicensed radio spectrum, the method further comprising the coordinating user equipment:

receiving a configuration for operating the local wireless network using the unlicensed radio spectrum from the base station; and

the allocating the air interface resources to each of the multiple user equipments for communication using the local wireless network comprising scheduling resources of the unlicensed radio spectrum for communication using the local wireless network.

Example 15: A user equipment comprising:

a wireless transceiver;

a local wireless network transceiver;

a processor; and

instructions for a communication manager application that are executable by the processor to configure the user equipment to perform any one of the methods of examples 1 to 14.

Although aspects of user-equipment-coordination-set scheduling have been described in language specific to features and/or methods, the subject of the appended claims is not necessarily limited to the specific features or methods described. Rather, the specific features and methods are disclosed as example implementations of user-equipment-coordination-set scheduling, and other equivalent features and methods are intended to be within the scope of the appended claims. Further, various different aspects are described, and it is to be appreciated that each described aspect can be implemented independently or in connection with one or more other described aspects.

1. A method for scheduling local wireless network communication by a user equipment configured as a coordinating user equipment for a user-equipment-coordination set, UECS, in a wireless communications network, the method comprising the coordinating user equipment:
receiving an indication from a base station specifying multiple user equipments to include in the user-equipment-coordination set;
allocating air interface resources to each of the multiple user equipments for communication using a local wireless network;
transmitting a UECS resource grant to each of the multiple user equipments for communication using the local wireless network, the UECS resource grant indicating the allocated air interface resources;
communicating with the multiple user equipments, using the air interface resources granted in the UECS resource grants for the local wireless network, to coordinate a joint communication between the user-equipment-coordination set and the base station; and
participating in the joint communication, with the multiple user equipments, to communicate data with the base station for a target user equipment in the user-equipment-coordination set.

2. The method of claim 1, further comprising the coordinating user equipment:
receiving a UECS report from a first user equipment of the multiple user equipments;
based on the received UECS report, determining a revised configuration of the first user equipment including one or more parameters for communication using the local wireless network; and
transmitting the revised configuration to the first user equipment, the revised configuration directing the first user equipment to use the one or more parameters to reconfigure the first user equipment for communication using the local wireless network.

3. The method of claim 2, wherein the UECS report includes a UECS-specific Channel Quality Indicator, CQI, for the local wireless network, measured by the first user equipment, and wherein the one or more parameters includes an indication of a Modulation and Coding Scheme, MCS, to use for communication using the allocated air interface resources for the local wireless network between the coordinating user equipment and the first user equipment.

4. The method of claim 2, wherein the UECS report includes a UECS-specific power headroom report for the local wireless network, and wherein the one or more parameters includes a UECS-specific power control command to indicate a transmit power for UECS transmissions by the first user equipment using the allocated air interface resources.

5. The method of claim 2, wherein the one or more parameters includes a timing advance that specifies the timing advance for the first UE to use for coordination of joint communication with the base station.

6. The method of claim 1, further comprising the coordinating user equipment:
receiving a coordination buffer status report of pending uplink data from a second user equipment;
based on the coordination buffer status report, scheduling air interface resources of the local wireless network to coordinate joint transmission of pending uplink data of the second user equipment; and
transmitting a scheduling command including a resource schedule to the second user equipment, the resource schedule including an indication of the scheduled air interface resources.

7. The method of claim 6, further comprising the coordinating user equipment:
transmitting scheduling commands including respective resource schedules to other user equipments in the UECS, wherein the respective resource schedules are specific to an individual user equipment in the UECS, a subset of user equipments in the UECS, or all the user equipments in the UECS.

8. The method of claim 1, further comprising the coordinating user equipment:
receiving timing and frequency information for UECS synchronization signals from the base station; and
transmitting the UECS synchronization signals over the local wireless network, the transmitting being effective to enable the multiple user equipments receiving the UECS synchronization signals to synchronize communication with the coordinating user equipment over the local wireless network.

9. The method of claim 8, wherein a UECS synchronization signal is specific to an individual user equipment in the UECS, a subset of user equipments in the UECS, or all the user equipments in the UECS.

10. The method of claim 1, further comprising the coordinating user equipment:
receiving a resource grant of licensed spectrum resources from the base station, the resource grant including an indication of the licensed spectrum resources allocated by the base station for the local wireless network; and
wherein the allocating the air interface resources to each of the multiple user equipments comprises allocating at least a portion of the indicated licensed spectrum resources to each of the multiple user equipments for communication using the local wireless network.

11. The method of claim 10, wherein the resource grant of licensed spectrum resources from the base station includes resources granted for the local wireless network and resources granted for communication between the base station and the UECS.

12. The method of claim 1, further comprising the coordinating user equipment:
receiving a Citizens Broadband Radio Service, CBRS, radio spectrum grant from the base station, the CBRS radio spectrum grant including an indication of CBRS radio spectrum resources allocated by the base station for the local wireless network; and
the allocating the air interface resources to each of the multiple user equipments comprising allocating the indicated CBRS radio spectrum resources to each of the multiple user equipments for communication using the local wireless network.

13. The method of claim 12, wherein the CBRS radio spectrum grant from the base station includes resources granted for the local wireless network and resources granted for communication between the base station and the UECS.

14. The method of claim 1, wherein the local wireless network communicates using unlicensed radio spectrum, the method further comprising the coordinating user equipment:
receiving a configuration for operating the local wireless network using the unlicensed radio spectrum from the base station; and
the allocating the air interface resources to each of the multiple user equipments for communication using the local wireless network comprising scheduling resources of the unlicensed radio spectrum for communication using the local wireless network.

15. A user equipment comprising:
a wireless transceiver;
a local wireless network transceiver;
a processor; and
instructions for a communication manager application that are executable by the processor to configure the user equipment to:
receive an indication from a base station specifying multiple user equipments to include in a user-equipment-coordination set;
allocate air interface resources to each of the multiple user equipments for communication using a local wireless network;
transmit a UECS resource grant to each of the multiple user equipments for communication using the local wireless network, the UECS resource grant indicating the allocated air interface resources;
communicate with the multiple user equipments, using the air interface resources granted in the UECS resource grants for the local wireless network, to coordinate a joint communication between the user-equipment-coordination set and the base station; and
participate in the joint communication, with the multiple user equipments, to communicate data with the base station for a target user equipment in the user-equipment-coordination set.

16. The user equipment of claim 15, the instructions further executable to configure the user equipment to:
receive a UECS report from a first user equipment of the multiple user equipments;
based on the received UECS report, determine a revised configuration of the first user equipment including one or more parameters for communication using the local wireless network; and
transmit the revised configuration to the first user equipment, the revised configuration directing the first user equipment to use the one or more parameters to reconfigure the first user equipment for communication using the local wireless network.

17. The user equipment of claim 16, wherein the UECS report includes a UECS-specific Channel Quality Indicator, CQI, for the local wireless network, measured by the first user equipment, and wherein the one or more parameters includes an indication of a Modulation and Coding Scheme, MCS, to use for communication using the allocated air interface resources for the local wireless network between the coordinating user equipment and the first user equipment.

18. The user equipment of claim 16, wherein the UECS report includes a UECS-specific power headroom report for the local wireless network, and wherein the one or more parameters includes a UECS-specific power control command to indicate a transmit power for UECS transmissions by the first user equipment using the allocated air interface resources.

19. The user equipment of claim 16, wherein the one or more parameters includes a timing advance that specifies the timing advance for the first UE to use for coordination of joint communication with the base station.

20. The user equipment of claim 15, the instructions further executable to configure the user equipment to:
receive a coordination buffer status report of pending uplink data from a second user equipment;
based on the coordination buffer status report, schedule air interface resources of the local wireless network to coordinate joint transmission of pending uplink data of the second user equipment; and
transmit a scheduling command including a resource schedule to the second user equipment, the resource schedule including an indication of the scheduled air interface resources.
